(19) United States
(12) Patent Application Publication
(10) Pub. No.: US 2024/0202862 A1
(43) Pub. Date: Jun. 20, 2024

(54) GRAPHICS AND COMPUTE API EXTENSION FOR CACHE AUTO TILING

(71) Applicants: Advanced Micro Devices, Inc., Santa Clara, CA (US); ATI Technologies ULC, Markham (CA)

(72) Inventors: Guennadi Riguer, Markham (CA); Mark Satterthwaite, Santa Clara, CA (US); Jeremy Lukacs, Santa Clara, CA (US); Zhuo Chen, Markham (CA); Gareth Havard Thomas, Milton Keynes (GB)

(73) Assignees: Advanced Micro Devices, Inc., Santa Clara, CA (US); ATI Technologies ULC, Markham, ON (CA)

(21) Appl. No.: 18/085,356

(22) Filed: Dec. 20, 2022

(51) Int. Cl. G06T 1/60; G06F 9/48; G06T 1/20

(52) U.S. Cl. CPC G06T 1/60; G06F 9/4881; G06T 1/20

(57) ABSTRACT

A processing device and a method of auto-tiled workload processing is provided. The processing device includes memory and a processor. The processor is configured to store instructions for operations to be executed on an image to be divided into a plurality of tiles, store information associated with the operations, select one of the operations for execution and execute an auto-tiling plan for the operation based on the information associated with the operations. The auto-tiling plan comprises, for example, determining a number of tiles used to divide the image and determining a size of one or more of the tiles of the image.

### BACKGROUND

Graphics processing includes the rendering of a three dimensional (3D) scene onto a two dimensional (2D) screen. The 3D scene is rendered on a display screen, via a graphics pipeline, which includes different stages of processing. Graphics processing commands of a command stream are received (e.g., from an application) and computation tasks are provided (e.g., to an accelerated processing device, such as a GPU) for execution of the tasks.

Graphics are rendered on a display screen using primitives (e.g., triangles, quadrilaterals or other geometric shapes). The graphics processing commands include, for example, the number of primitives, the location of each primitive and attributes of each primitive to be rendered on the display screen.

### BRIEF DESCRIPTION OF THE DRAWINGS

A more detailed understanding can be had from the following description, given by way of example in conjunction with the accompanying drawings wherein:

FIG. 1 is a block diagram of an example device in which features of the present disclosure can be implemented;

FIG. 2 is a block diagram illustrating additional details related to execution of processing tasks on the accelerated processing device shown in FIG. 1;

FIG. 3 is a block diagram illustrating an example interconnection and information flow of a processing device in which features of the present disclosure can be implemented;

FIG. 4 is a flow diagram illustrating an example method of auto-tiled workload processing according to features of the present disclosure;

FIG. 5 is a block diagram illustrating an example of determining a tile size based on an estimated tile dilation size according to features of the present disclosure.

### DETAILED DESCRIPTION

The graphics pipeline can be simplified to include a front end geometry portion and a back end portion. For example, the front end geometry portion of the pipeline includes several shader stages (e.g., vertex shader stage, hull shader stage, tesselator stage, domain shader stage and geometry shader stage). During the shader stages, the primitives are received as 3 dimensional (3D) objects and transformed to 2D objects to be rendered onto a 2D screen. The back end portion includes a rasterizer stage and pixel shader stage. During the rasterizer stage, an on-screen location of each primitive to be projected onto the 2D screen is determined. For example, during rasterization, an accelerated processing device (e.g., GPU) determines, for each primitive, which pixels (or sub-pixel samples) correspond to each primitive to be rendered onto the 2D screen. During the pixel shader stage, values (e.g., brightness and color) are calculated for the pixels corresponding to the primitives.

Cache memory (hereinafter “cache”), is used to accelerate access to data stored in a larger memory portion (e.g., main memory) by storing copies of data in the cache that are frequently accessed in larger memory portion. When a processor requests access (e.g., read data from or write data to) to the larger memory portion (e.g., identified by an address), the processor first determines whether a copy of the data is stored in the cache. If it is determined that a copy of the data is stored in the cache, the processor accesses the cache, facilitating a more efficient accessing of the data.

Frequently accessed data is copied from the memory to the cache in blocks of fixed size, typically referred to as cache lines. When a cache line is copied to the cache, a cache entry is created (i.e., placed in the cache), which includes the copied data and the requested memory address (e.g., a tag). If the tag is located in the cache, a cache hit occurs and the data is accessed in the cache line. If the tag is not in the cache, a cache miss occurs. A new entry is allocated to the cache, data from the larger memory is copied to the cache and the data is accessed. Existing entries may be replaced (e.g., evicted) by new entries according to different mapping policies, which include direct mapping and associative mapping.

Caches are typically located closer to the processor (i.e., local cache) such that data can be accessed more quickly to decrease memory bandwidth and access latency to memory. The data is processed (e.g., by the GPU) more efficiently by reusing previously processed data that is stored in local memory (e.g., local cache memory of the GPU) rather than processing the data using non-local or remote memory (e.g., main memory). However, when data, resulting from the execution of a set of operations during a processing stage of a processing pipeline, is sufficiently large such that the data does not fit in the cache, data is flushed from the cache and stored in remote or non-local memory (e.g., main memory). Accordingly, a set of operations during a next stage of a processing is executed by accessing the data from non-local memory (e.g., main memory), which increases the memory bandwidth and the access latency to memory.

Some caches, such as a memory access at last level (MALL) cache, are large in size to facilitate reducing memory bottlenecks, increase bandwidth, and improve overall efficiency during graphics processing. However, despite their larger size, these caches are not capable of holding a complete working set of data for some emerging multi-pass workloads, particularly at higher resolutions.

One technique for reducing the amount of local memory and bandwidth during graphics processing is known as tiling (or binning). Tiling reduces the amount of local memory and bandwidth used to render a frame in comparison to rendering the entire frame at once by splitting the frame into sections (e.g., tiles or bins) and rendering one tile of a frame before rendering another tile of the frame. Because one tile of a frame is rendered before another tile of the frame, more data can be reused across multiple processing passes.

For example, if a frame (or image) is split into four equal tiles (i.e., top left quadrant, top right quadrant, bottom left quadrant and bottom right quadrant), a first tile (e.g., top left quadrant) is rendered before proceeding to render one of the next tiles. Then, one of the other tiles (e.g., top right quadrant) is rendered before proceeding to render one of the last two tiles, and so on, until each of the tiles of the frame are rendered.

Different hardware (e.g., GPU) of a graphics device (e.g., a graphics card) uses different sets of low-level commands to perform various graphics processing tasks. A graphics application programming interface (API) operates as a “universal language” which is used by applications to communicate with the graphics device (e.g., a GPU of the graphics device) without having to deal with hardware specific low-level commands for each accelerated processing device (“APD”), such as a GPU, on the graphics device. That is, an API is defined to provide a common interface which allows operating system designers to support different graphics devices without worrying about the hardware specific low-level commands for the different devices.

Device manufacturers implement a device driver that performs graphics processing operations (e.g., graphics rendering operations) and provides pixel output to a display device for display. Device drivers vary between different graphics devices (i.e., different at the hardware level), but the API remains consistent so that the operating system does not have to deal with the hardware. At the device, the driver is used to accept commands in an API and translate them into low-level commands that a particular APD of a graphics device can understand.

While workload tiling can be implemented by application developers, the complexity of such ad hoc implementations is prohibitive (e.g., complex) for the developers. In addition, efficient and accurate tuning of tiling parameters, for different GPUs (e.g., different cache sizes and other architectural differences) presents developers with additional challenges. For example, tiling parameters are tuned such that a number of tiles and sizes of tiles that are used results in an amount of data (i.e., data footprint size), resulting from the execution of each operation of a workload, fits into the cache.

Some conventional techniques attempt to deal with these challenges (e.g., efficient use of different types of caches for tiling) using specific APIs (e.g., work graph or render passes, such as for example, in Vulkan). However, these APIs are specialized for particular tasks and place additional burdens on developers to change their solutions to these specialized APIs.

Features of the present disclosure include devices and methods which augment existing graphics and compute APIs with additional functionality to provide a more efficient use of different caches in different APDs with little intervention from developers.

Features of the present application can be implemented for both compute-intensive applications, such as graphics processing applications (e.g., 3D rendering and video games) as well as compute processing resources (e.g., CPUs, APUs and GPUs).

Features of the present disclosure add an explicit API extension, including tiling chains of operations, to enable cache-aware workload transformations in the device drivers across different GPUs. For example, as described in more detail herein, explicit API extensions result in recording tiling operations a single time in a command buffer without application developers having explicit knowledge of the specific characteristics of the workload to be executed by the GPU architecture.

Some APIs typically use a notion of command buffers (also known as command or display lists in some APIs) in which operations are stored before they are submitted to the GPU for execution. Features of the present disclosure leverage these similar constructs in the different APIs and record them explicitly as constructs to be tiled at runtime by the driver. The processing of the operations, within the command buffer (or similarly, a display list), is defined to be tiled to improve cache locality. Additional API commands (e.g., hints and annotations) are used which include information (e.g., used by the scheduling processor) to determine whether or not to process the tiles according to the operations stored in the command buffer.

For example, conventional processing of a sequence of 2 operations executed on an image would include applying a first operation (e.g., dispatch operation) to an input image to produce a first output image. The output image (e.g., data of the output image) would be consumed by a second operation (e.g., draw operation) to produce a second output image. These operations are recorded, prior to their execution, in a command list and cued for execution.

Features of the present disclosure would also include recording the 2 operations in the command list for execution. However, when the operations are cued for execution, instead of executing the operations a single time for the whole image, a decision is made to execute each pass for some portion (e.g., a tile) of the image before executing each pass for the next portion (e.g., next tile) of the image. In some cases, the tiles have different sizes (e.g., tile size adjustment due to tile size dilation and tiling granularity requirements).

The number and size of the tiles used to split the images for executing an application, depends on, for example, the cache size of a GPU and the compression technique being used to execute the image processing. For example, if the cache size is too small relative to the size of the tiles being used, some of the data resulting from the execution of a pass of a tile will be flushed from the cache to make room for the data resulting from the execution of a pass of the next tile, which over time will result in an increase in cache misses. Accordingly, the number and size of the tiles used to split an image being processed on a GPU is determined such that the GPU cache will be able to store the data for multiple tiles, which are processed (e.g., overlapping processing) over time, to reduce the number of cache misses.

However, the number and size of the tiles used to split images being processed can differ from one GPU to another GPU due, for example, to different cache sizes of each GPU.

Features of the present disclosure add small changes to the existing API such that the number and size of the tiles selected for splitting images efficiently processes the images (e.g., reduces the number of cache misses) with minimal API involvement on the developer side. (i.e., the developer can rely on the existing API constructs). Then, based on information provided in the executing application, and other heuristics, an operation execution plan is selected for playing back the operations stored in the command buffer.

The present application provides a method of auto-tiled workload processing. The method comprises storing instructions for operations to be executed on an image to be divided into a plurality of tiles, storing information associated with the operations, selecting one of the operations for execution and executing the one operation according to an auto-tiling plan based on the information associated with the one operation.

The present application provides a processing device used for auto-tiled workload processing. The processing device comprises memory, including cache memory, and a processor. The processor is configured to store instructions for operations to be executed on an image to be divided into a plurality of tiles, store information associated with the operations, select one of the operations for execution and execute the one operation according to an auto-tiling plan based on the information associated with the one operation.

The present application provides a non-transitory computer-readable storage medium having instructions thereon for causing a computer to execute a method of auto-tiled workload processing comprising storing instructions for operations to be executed on an image to be divided into a plurality of tiles, storing information associated with the operations, selecting one of the operations for execution and executing the one operation according to an auto-tiling plan based on the information associated with the one operation.

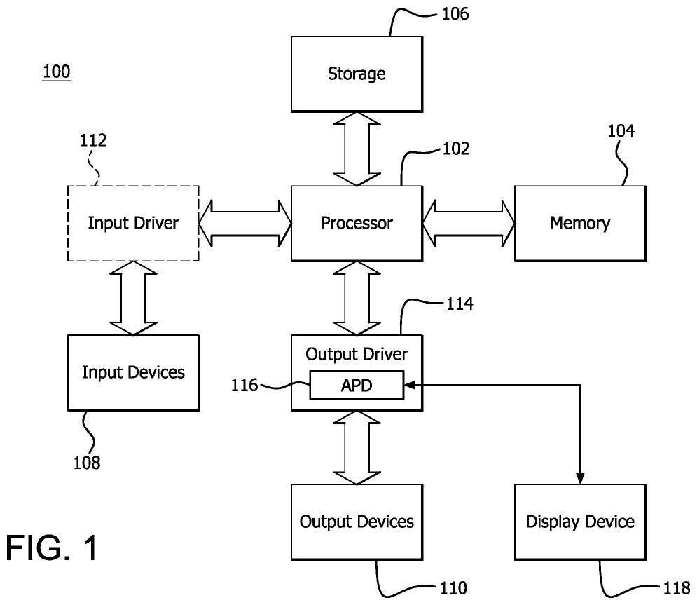

FIG. 1 is a block diagram of an example device 100 in which one or more features of the disclosure can be implemented. The device 100 can include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. The output driver 116 includes an APD 116 which is coupled to a display device 118. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm performs the functionality described herein.

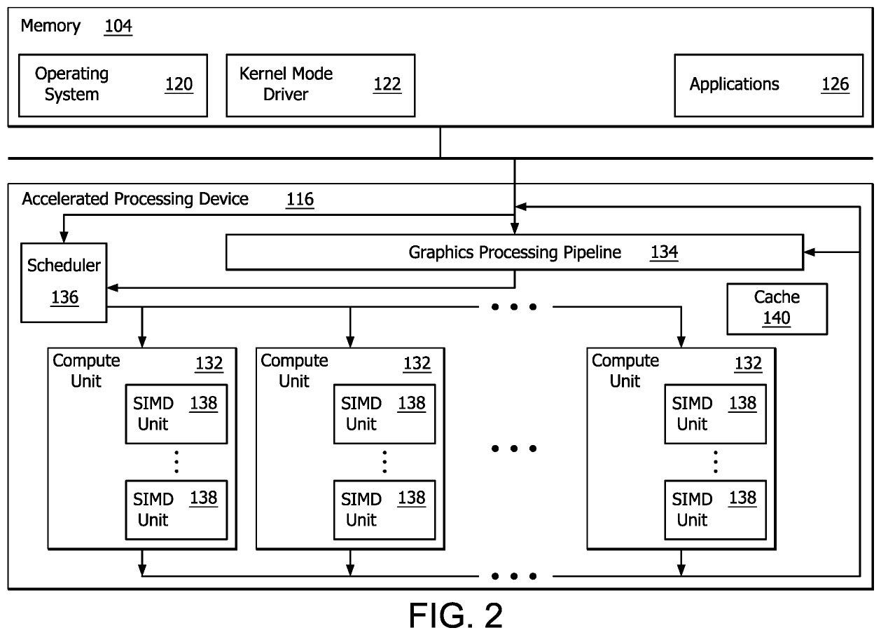

FIG. 2 is a block diagram of the device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an API to software (e.g., applications 126) executing on the processor 102 to access various functionality of the APD 116. The kernel mode driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that perform operations at the request of the processor 102 in a parallel manner according to a SIMD paradigm. Each compute unit also includes a local cache 140. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 performs operations related to scheduling various wavefronts on different compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

The APD 116 is configured to implement features of the present disclosure by executing a plurality of functions as described in more detail below. For example, the APD 116 is configured to receive images comprising one or more 3D objects (e.g., when implementing graphics processing applications), divide images into a plurality of tiles, execute a visibility pass for primitives of an image, execute coarse level tiling for the tiles of the image, divide the tiles into fine tiles and execute fine level tiling of the image. Optionally, the front end geometry processing of a primitive determined to be in a first one of the tiles can be executed concurrently with the visibility pass. Tile processing can also include overlapping processing for both compute-intensive applications and compute processing resources.

Features of the present application can be implemented for both compute-intensive applications, such as graphics processing applications (e.g., 3-D rendering and video games) as well as compute processing resources (e.g., CPUs, APUs and GPUs).

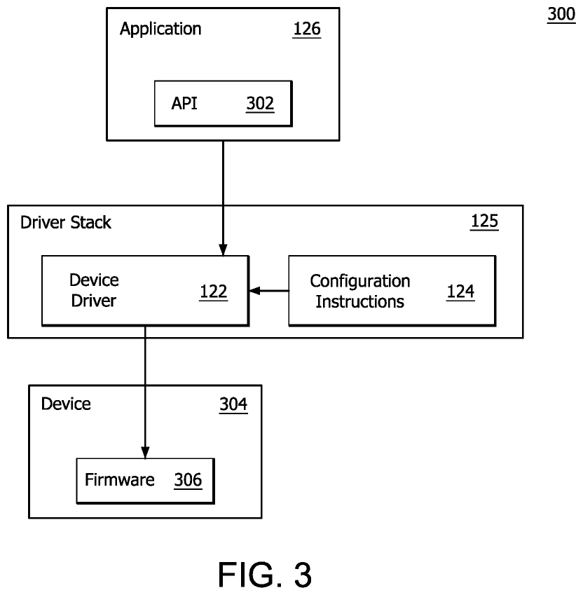

FIG. 3 is a block diagram illustrating an example interconnection and information flow of a processing device 300 in which features of the present disclosure can be implemented. As shown in FIG. 3, the device 300 includes an application 126 with one or more APIs 302, a driver stack 125 including device driver 122 and configuration instructions 124 and device 304 (e.g., output driver 114 shown in FIG. 1).

The driver stack 125 includes device driver 122 used to interface between the operating system 120 and the firmware 306 and configuration instructions 124. The configuration instructions 124 include, for each application 126 to be processed, predetermined (e.g., determined prior to application runtime) hardware parameter settings, used to tune hardware parameters configured to control the operation of the hardware during execution of each application 126.

Firmware 306 includes hardware parameters and associated values to control operation of hardware of the device 304 (e.g., graphics card) and provide an interface between the hardware (e.g., APD 116) of the device 304 and device driver 122. As described above, firmware is stored in non-volatile memory (e.g., a hard-disk, motherboard boot read only memory (ROM), and BIOS memory). Processor 102 is configured to identify an application executing at device 304 (e.g., executing on APD 116), and read firmware 306 from non-volatile memory to be processed at device 304, as shown in FIG. 3. The firmware 306 is used, along with the device driver 122, to control operation of hardware (e.g., APD 116) of device 304.

The APD 116 is configured to execute (e.g., schedule for execution, execute) an application 126 using, for example, the operating system 120, the device driver 122 and the configuration instructions 124. For example, the operating system 120 communicates with firmware 306 and provides an interface to the hardware for application 126 executing on the APD 116. The device driver 122 controls operation of the APD 116 by, for example, providing API 302 to applications 126 executing on the APD 116 to access various functionality of the APD 116. Examples of APIs include but are not limited to open computing language (OpenCL), open graphics library (OpenGL) and DirectX APIs.

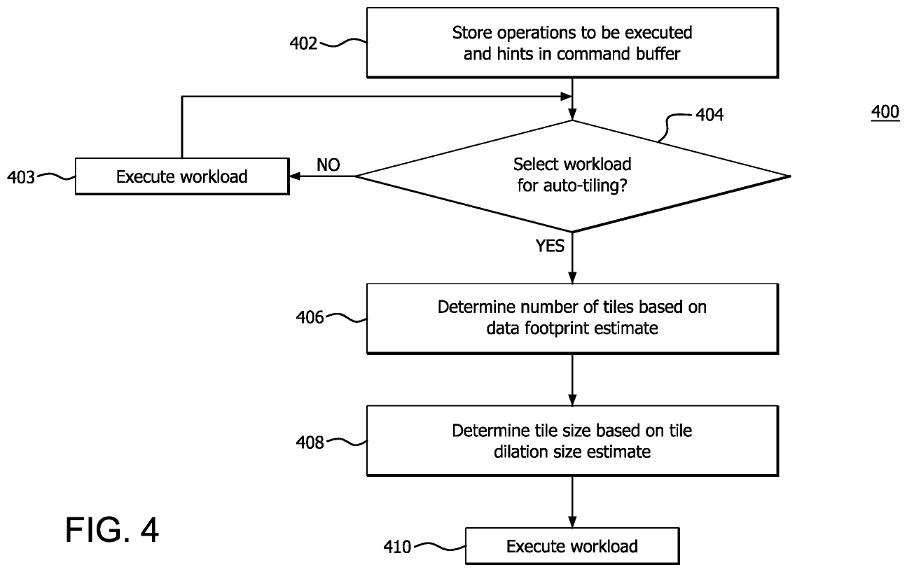

FIG. 4 is a flow diagram illustrating an example method 400 of auto-tiled workload processing according to features of the present disclosure. The method 400 can be implemented for graphics processing (e.g., 3D rendering) and compute operations.

As shown at block 402, the method 400 includes storing a sequence of operations (e.g., dispatch operation, draw operation), to be executed for an application, in a command buffer.

As shown at block 404, a determination is made for whether or not to select a workload (i.e., select an operation to be executed for one or more tiles of an image) for auto-tiling execution. That is, a determination is made for whether or not to select a workload (e.g., an operation) for implementing a specific auto-tiling execution plan illustrated below at blocks 406 and 408.

When a workload (e.g., operation to be executed for one or more tiles of an image) is not selected for auto-tiling, the workload is executed, at block 403, without determining an auto-tiling execution plan (e.g., executed using conventional processing) and the method then proceeds back to block 404 to determine if a next workload is to be selected for auto-tiling execution.

The workload is selected from a command list (e.g., auto-tiling extension) in the API which includes operations (e.g., dispatches) to be selected for auto-tiling. A library interface is, for example, used to create an auto-tiling command list and provide annotations for the operations recorded in the command list. An additional debug function is provided to query command list validation results from the driver. When an auto-tiling command list is created and stored (and optionally validated), the command list can be executed as a typical command list. The auto-tiling command list is internally tagged in the driver when it is created through the library.

Workloads which are selected for auto-tiling include multi-pass rendering and compute workloads that execute using a large amount of data (i.e., data read from and written to memory), such as volumetric effects and denoising workloads. Workloads can also be selected for auto-tiling based on data dependencies and data reuse. Accordingly, selecting workloads for auto-tiling that execute using a large amount of data can limit the overhead used to execute smaller workloads in which the data can fit into the cache.

When the storing of the command list is completed, an auto-tiling execution plan is created that determines tile sizes for each of the operation within tile ranges, the order in which tiled dispatches are executed and any barriers between them). The execution plan is then used to generate a hardware executable command buffer by replaying the recorded commands back according to the auto-tiling execution plan.

When a workload is selected for auto-tiling, the method proceeds to blocks 406 and 408.

Blocks 406 and 408 illustrate an example of determining an auto-tiling execution plan for a selected workload. In this example, the execution plan includes determining a number of tiles and tile sizes used to execute a selected workload (i.e., a workload selected for auto-tiling) based on information (e.g., hints) provided by the application. The example method 400 includes determining a number of tiles and then determining tile sizes. However, features of the present disclosure can also be implemented by first determining tile sizes and then determining the number of tiles. In addition, the determination of either the number of tiles or the size of the tiles can be used to determine the other. That is, a determined number of tiles can be used to determine the size of one or more tiles. Likewise, a determined size of one or more tiles can be used to determine the number of tiles.

In addition, determining the number of tiles and tile sizes can be performed by initially determining (e.g., roughly determining) a number of tiles and tile sizes and then refining the number of tiles and tile sizes according to tile dilation.

As shown at block 406, the method 400 includes determining a number of tiles used to execute a workload based on an estimated data footprint (i.e., amount of data read from and written to memory to execute an operation). The data footprint is estimated from information in the application. For example, based on information (e.g., hints) provided by the application, a processor estimates a data footprint. Hints for estimating a data footprint include, for example, data types, estimates for accessed data sizes, data dependencies and estimated compression ratios for specific data.

The data footprint is an estimated value of the total amount of data read from and written to memory to execute an operation (e.g., dispatch). The data footprint estimate provides an indication of the number of tiles to be used to execute a workload such that the data resulting from the execution of each operation of the workload fits into the cache. For example, if implementing a driver generating execution plan for a tiled command list, when the data footprint is set to zero, the processor causes the driver to estimate the size based on resource barriers, currently bound resources or some other heuristics. Alternatively, an execution plan for a tiled command list can be implemented using a processor (e.g., command processor or another processor of an APD to compute an execution plan and schedule tiled execution.

As shown at block 408, the method 400 includes determining sizes of tiles used to execute a workload based on an estimated tile count and tile dilation size. That is, based on information (e.g., hints) provided by the application, a tile dilation size is estimated for one or more tiles. For example, the processor instructs the driver to estimate a tile dilation size based on information (e.g., hints) provided by the application. Alternatively, a tile dilation size can be derived from information in the shader or kernel.

Hints for estimating a tile dilation size include information indicating whether or not a 1:1 correspondence exists between a portion (e.g., one or more pixels) of an input image and a portion (e.g., one or pixels) of an output image or whether or not that the data read from memory to execute an operation indicates a dilation of a bound size relative to its pixel location or a location identified by a thread ID (e.g., “gather” access pattern).

The auto-tiling executes on the assumption that the intermediate data in each producer operation-consumer operation pair is either addressed with a 1:1 thread ID to resource address mapping or the consumer operation reads data with some dilation of a bound size relative to its thread ID (e.g., “gather” access pattern).

For example, a 1:1 address mapping to thread ID correspondence means that the amount of stored data representing a portion (e.g., one or more pixels) of an input image is the same as the amount of data representing a portion of an output image (e.g., an image upon which an operation is performed on the input image).

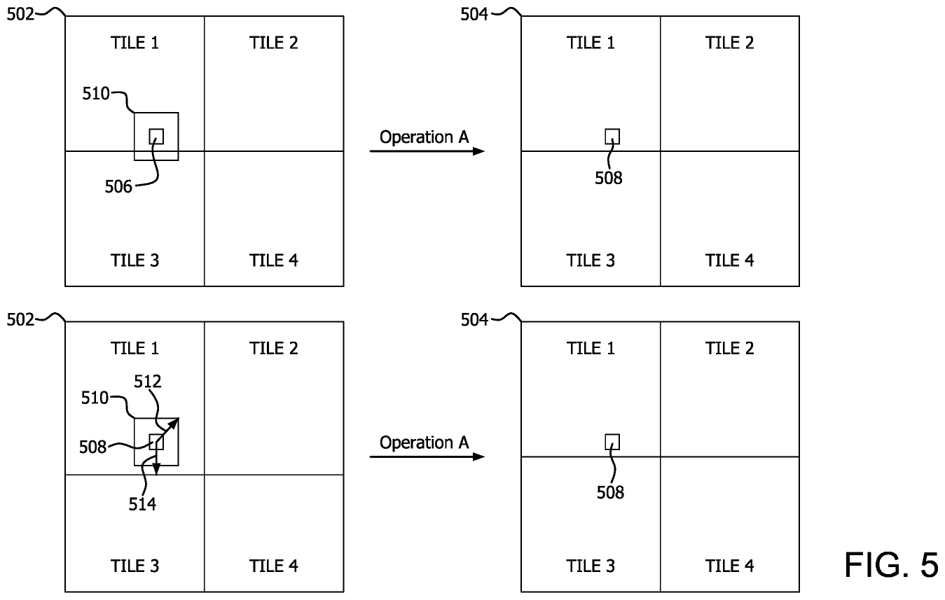

FIG. 5 is a block diagram illustrating an example of determining a tile size based on an estimated tile dilation size according to features of the present disclosure. For simplified explanation, the example shown in FIG. 5 includes 2 images (an input image 502 and an output image 504) each divided by 4 tiles (i.e., a 2×2 tile matrix) and a single operation (Operation A) performed on the input image 502 to produce the output image 504. Features of the present disclosure can be implemented, however, using any number of additional operations to produce any number of additional output images. Features of the present disclosure can also be implemented using any number of tiles and tile sizes different than those shown in FIG. 5.

The top of FIG. 5 illustrates an example in which a 1:1 correspondence does not exist because the data from multiple pixels representing a pixel in the input image (e.g., a filter comprising the data of multiple pixels around the input pixel) is used to determine a value of a pixel in an output image. Another example in which there is not a 1:1 correspondence is when multiple pixels in the output image is used to represent a single pixel in the input image (e.g., pixel data is scattered to larger area in output image).

FIG. 5 illustrates an example in which a 1:1 correspondence does not exist because the data from multiple pixels representing a pixel in an input image is used to determine a value of a pixel in an output image. For example, the top of FIG. 5 includes an input image 502 and an output image 504 each including 4 tiles (i.e., a 2×2 tile matrix). The input image 502 includes a pixel 506 (i.e., direct mapped pixel) and the output image 504 includes a co-located pixel 508. When operation A is executed on the input image 502, a filter is applied to the input pixel and the data of multiple pixels around the input pixel 506 (represented by box 510) is read from memory and used to generate a value of the co-located pixel 508 in the output image 504. Therefore, because box 510 overlaps Tile 1 and Tile 3, a value of the co-located pixel 508 in the output image 504 is generated by sampling pixels in both Tile 1 and Tile 3 (i.e., pixels within box 510).

However, execution of the input image 502 and the output image 504 includes processing the corresponding tiles of each image before processing the next corresponding tiles from each image. For example, the pixels from Tile 1 of the input image 502 are processed (e.g., by a compute unit 132 in FIG. 2) and the data is stored in local cache memory (e.g., cache 140 in FIG. 2), followed by the pixels from Tile 1 of the output image 504, followed by the pixels from Tile 2 of the input image 502, followed by the pixels from Tile 2 of the output image 504, and so on until each of the tiles are processed. Therefore, if the tiles of the input image 502 and the output image are the same size, when Tile 1 of the output image 504 is ready for processing, the pixel values within box 510 in Tile 3 (which are used to process the co-located pixel 508 in Tile 1 of the output image 504) are not yet available (i.e., not stored in the local cache) to generate the co-located pixel 508 in Tile 1 of the output image 504.

To make the data of the pixels within the box 510 available for processing and increase the probability that the data is stored in local cache memory, the tile sizes are changed based on the estimated tile dilation such that each of the pixels within the box 510 of the input image 502 are processed prior to processing the co-located pixel 508 in the output image 504.

Accordingly, as shown at the bottom of FIG. 5, the size of Tile 1 in the input image 502 is sized such that each of the pixels within the box 510 are processed and stored in the local cache memory prior to processing Tile 1 of the output image 504 to produce the co-located pixel 508.

The tile dilation size is expressed as maximum distance relative to a thread's current identifier (thread ID). For example, as shown at the bottom of FIG. 5, a tile dilation size is estimated as the distance from the input pixel 506 to a corner of the box 510, which is represented by arrow 512. The size of Tile 1 in the input image 502 is then increased by a distance (represented by arrow 514) equal to the distance represented by arrow 512. The location of the corner of the box 510 is, for example, provided by the thread ID. The estimated distance (i.e., estimated tile dilation) can be calculated as a number of pixels or a number of coordinates (e.g., 3 coordinates in a 3D space) in one or more dimensions.

No dilation (e.g., a dilation of image or pixel coordinates (0, 0, 0) of a 3D space) is used when there is a 1:1 resource address mapping.

As shown at block 410, the method 400 includes executing the workload. For example, Operation A is performed on Tile 1 of the input image 502 to generate the pixels values of Tile 1 of the output image 504. Operation A is also performed on the remaining tiles of the input image 502 to generate the pixels values of the corresponding tiles of the output image 504. The images processed according to the features of the present disclosure are then provided for display (e.g., on display device 118).

Accordingly, instead of executing an operation a single time for the whole image, the operations are executed multiple times in tiles, repeating processing across each processing pass according to features of the present disclosure described above. That is, each operation is executed separately for each tile of the image. Because a plan of operation execution is selected based on the hints, the operations are executed without explicitly defining the parameters (e.g., starting and ending pixel or thread coordinates) of each operation to be executed. That is, in contrast to conventional techniques which need to store the operations multiple times to execute each operation multiple times, features of the present disclosure store each operation a single time and then execute each operation multiple times according to the execution plan.

When one or more specifications of an execution plan (e.g., the number of tiles or tile dilation size), is used to execute an operation (i.e., a workload), the execution plan is used to execute the instructions for the next operation (e.g., dispatch or draw) stored in the command buffer. Different subsequent execution plan specifications override previous execution plan specifications. Barriers are automatically inserted between appropriate draw or dispatch operations to ensure correctness of execution in accordance with the sequence of commands originally provided by the application and recorded in the command list.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the APD 116, the scheduler 136, the graphics processing pipeline 134, the compute units 132, the SIMD units 138, and the cache 140 may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method of auto-tiled workload processing comprising;
storing instructions for operations to be executed on an image to be divided into a plurality of tiles;
storing information associated with the operations;
selecting one of the operations for execution; and
executing the one operation according to an auto-tiling plan based on the information associated with the one operation.

2. The method of claim 1, wherein the auto-tiling plan comprises determining a number of tiles used to divide the image.

3. The method of claim 2, further comprising estimating an amount of data used to execute the one operation on the image,
wherein the number of tiles is determined based on the estimated amount of data.

4. The method of claim 2, wherein the number of tiles is determined such that data, resulting from the execution of the one operation, fits into a local cache.

5. The method of claim 1, wherein the auto-tiling plan comprises determining a size of one or more of the tiles of the image.

6. The method of claim 5, further comprising estimating a tile dilation size of the one or more tiles to execute the one operation on the image,
wherein the size of the one or more tiles is determined based on the estimated tile dilation size.

7. The method of claim 6, wherein the tile dilation size is expressed as maximum distance relative to a location indicated by a thread identifier.

8. The method of claim 1, further comprising storing the information when the instructions for the operations are stored.

9. The method of claim 1, further comprising
storing an auto-tiling command list in an application programming interface comprising operations to be selected for auto-tiling execution; and
selecting the one operation for auto-tiling execution from the auto-tiling command list.

10. The method of claim 1, further comprising
storing, a single time, the instructions for each of the operations to be executed on the image; and
executing one or more of the operations multiple times on the image.

11. A processing device used for auto-tiled workload processing comprising:
memory comprising cache memory; and
a processor configured to:
store instructions for operations to be executed on an image to be divided into a plurality of tiles;
store information associated with the operations;
select one of the operations for execution; and
execute the one operation according to an auto-tiling plan based on the information associated with the one operation.

12. The processing device of claim 11, wherein the processor is configured to execute the auto-tiling plan by determining a number of tiles used to divide the image.

13. The processing device of claim 12, wherein the processor is configured to estimate an amount of data used to execute the one operation on the image,
wherein the number of tiles is determined based on the estimated amount of data.

14. The processing device of claim 12, wherein the processor is configured to determine the number of tiles such that data, resulting from the execution of the operation, fits into the cache memory local to the processor.

15. The processing device of claim 11, wherein the processor is configured to execute the auto-tiling plan by determining a size of one or more of the tiles of the image.

16. The processing device of claim 15, wherein the processor is configured to estimate a tile dilation size of the one or more tiles to execute the one operation on the image,
wherein the size of the one or more tiles is determined based on the estimated tile dilation size.

17. The processing device of claim 16, wherein the tile dilation size is expressed as maximum distance relative to a location indicated by a thread identifier.

18. The processing device of claim 11, further comprising a display device, wherein the image is provided for display on the display device.

19. The processing device of claim 11, further comprising
storing an auto-tiling command list in an application programming interface comprising operations to be selected for auto-tiling execution; and
selecting the one operation for auto-tiling execution from the auto-tiling command list.

20. A non-transitory computer-readable storage medium having instructions thereon for causing a computer to execute a method of auto-tiled workload processing comprising:
storing instructions for operations to be executed on an image to be divided into a plurality of tiles;
storing information associated with the operations;
selecting one of the operations for execution; and
executing the one operation according to an auto-tiling plan based on the information associated with the one operation.
